(19) United States
(12) Patent Application Publication
(10) Pub. No.: US 2003/0185240 A1
(43) Pub. Date: Oct. 2, 2003

(54) Secure service provider identification to content provider partner

(76) Inventor: Thai Hoa Vuong, Allen, TX (US)

Correspondence Address: James A. Harrison, P.O. Box 670007, Dallas, TX, 75367, US

(21) Appl. No.: 10/115,106

(22) Filed: Apr. 2, 2002

(51) Int. Cl. H04L 12/28

(52) U.S. Cl. 370/474; 370/395.52

(57) ABSTRACT

Secure service provider identification to content provider partner. Secure service provider identification is provided to a content provider partner by embedding a service provider digital signature on the user transaction request. The present invention provides an ISP/BW's secure identification between a user and a content provider, in each transaction between them. The ISP/BW's secure identification may be provided in each transaction between them. A content provider may have a partnership with an ISP, through which a user may purchase its contents. The content provider and/or ISP may provide an incentive, such an offered discount on the item and/or download cost, to stimulate business. The profit from the transaction may be shared between the ISP and the content provider. The content provider is then able to identify the user's transaction coming from a certain ISP for logging and verifying. The identifier to the content provider is employed using digital signature technology.

### TECHNICAL FIELD OF THE INVENTION

The invention relates generally to communication systems; and, more particularly, it relates to communication systems that include network access providers and content providers.

### BACKGROUND OF THE INVENTION

Data communication systems have been under continual development for many years. One deficiency of prior art data communication systems is the failure to provide secure identification of a network access provider to a content provider. Thus far, the prior art has failed to provide a sufficient solution that adequately ensures security while maintaining a high level of system performance across the communication system.

This lack of efficient security is particularly evident when users access the Internet through some means and then seek to access the goods and/or services provided by content providers who are supported and accessible via the Internet. One current method of attempting to ensure secure identification of a user is to employ something equivalent to usernames and passwords for each and every content provider site on the Internet. This can result in an incredibly large number of usernames and passwords for a single user to be able to ensure secure data transfer across the Internet.

Further limitations and disadvantages of conventional and traditional systems will become apparent to one of skill in the art through comparison of such systems with the invention as set forth in the remainder of the present application with reference to the drawings.

### SUMMARY OF THE INVENTION

Various aspects of the invention can be found in a communication system that provides secure service provider identification to content provider partner. The present invention is operable to provide for secure service provider identification to a content provider partner by embedding a service provider digital signature on the user transaction request. The present invention provides a secure identifier of an Internet Service Provider/Bandwidth (ISP/BW) provider establishing connectivity between a user and a content provider, in each transaction between them.

As one example embodiment, when a content provider forms a partnership with one or more ISPs, then the content provider and the ISP give some incentive for a user to purchase its contents (which may be music, various goods (clothing, electronics, books, among other things) and services) through an offered discount on the item and/or download cost. The profit from the transaction may then be shared between the ISP and the content provider. In the model of this embodiment, the content provider has been able to identify the user's transaction coming from a certain ISP for logging and verifying. The present invention provides such an identifier to the content provider using digital signature technology.

One embodiment employs a traffic-carrying box, in the ISP/BW provider system, that inserts a specific header that carries a specific digital signature of the ISP/bandwidth provider in the client request. The client request may in various formats depending on the particular system through which the user accesses the content provider. The content provider, that receives the client request, can use this specific header value to identify the ISP/BW provider from which the transaction originated.

There are a variety of manners in which the present invention may be practiced. The above-referenced description of the summary of the invention captures some, but not all, of the various aspects of the present invention. The claims are directed to some other of the various other embodiments of the subject matter towards which the present invention is directed. In addition, other aspects, advantages and novel features of the invention will become apparent from the following detailed description of the invention when considered in conjunction with the accompanying drawings.

### BRIEF DESCRIPTION OF THE DRAWINGS

A better understanding of the invention can be obtained when the following detailed description of various exemplary embodiments is considered in conjunction with the following drawings.

FIGS. 1 and 2 are functional block diagrams of a communication network formed according to the present invention.

FIGS. 3-7 are system diagrams illustrating embodiments of a secure communication system that is built according to the present invention.

FIG. 8 is a diagram illustrating an embodiment of content provider functionality that is supported according to the present invention.

FIG. 9 is an operational flow diagram illustrating an embodiment of a secure identification method that is performed according to the present invention.

FIG. 10 is an operational flow diagram illustrating another embodiment of a secure identification method that is performed according to the present invention.

### DETAILED DESCRIPTION OF A PREFERRED EMBODIMENT

The present invention is operable to provide for secure service provider identification to a content provider partner by embedding a service provider digital signature on the user transaction request. The present invention provides a secure identifier of an ISP/BW provider, that provides connectivity between a user and a content provider, in each transaction between them.

As one example embodiment, when a content provider forms a partnership with one or more ISPs, then the content provider and the ISP give some incentive for a user to purchase its contents (which may be music, various goods (clothing, electronics books, among other things) and services) through an offered discount on the item and/or download cost. The profit from the transaction may then be shared between the ISP and the content provider. In the model of this embodiment, the content provider has been able to identify the user's transaction coming from a certain ISP for logging and verifying. The present invention provides such an identifier to the content provider using digital signature technology.

One embodiment employs a traffic-carrying box, in the ISP/BW provider system, that inserts a specific header that carries a specific digital signature of the ISP/bandwidth provider in the client request. The client request may in various formats depending on the particular system through which the user accesses the content provider. The content provider, that receives the client request, can use this specific header value to identify the ISP/BW provider from which the transaction originated.

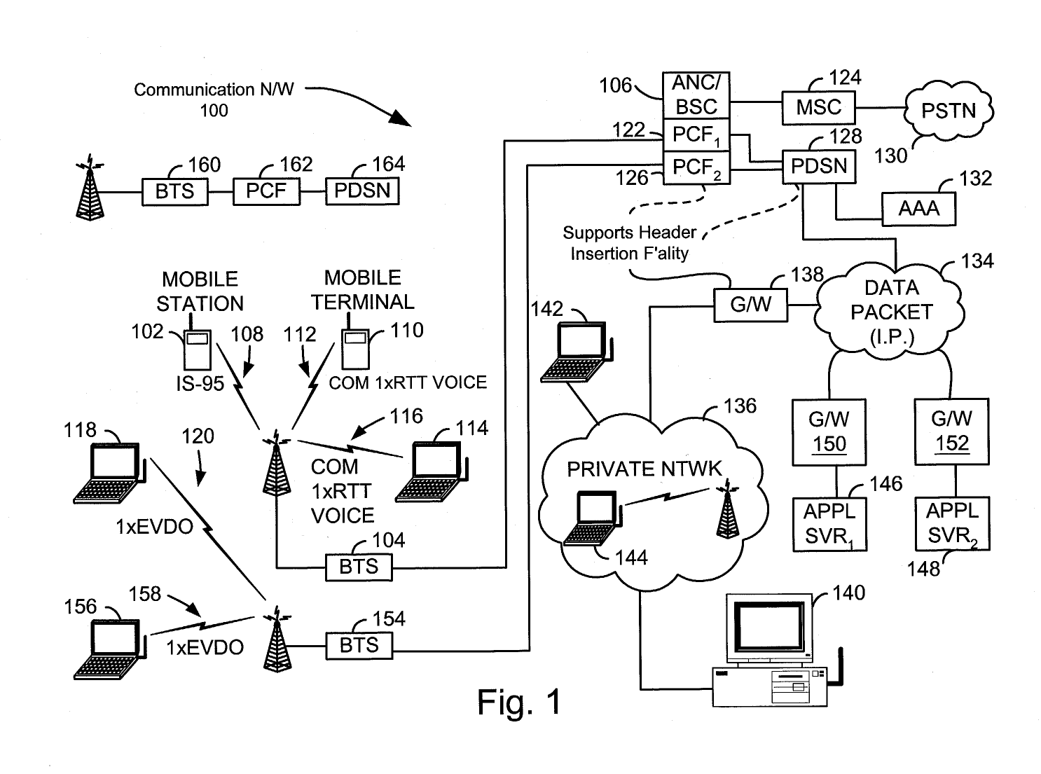

FIG. 1 is a functional block diagram of a communication network formed according to one embodiment of the present invention. As may be seen, a communication network 100 includes many networks that are coupled to operatively communicate with each other to enable a user in one type of network to communicate with a user in a different type of network. For example, the communication network 100 creates an ability for a wireline user terminal coupled to a private network to communicate with a mobile terminal through a wireless communication link. Such transparent operation with respect to the user is improving access to information and the ability for individuals to communicate to a level that is unprecedented. As discussed before, existing wireless networks have, heretofore, been adapted primarily for carrying voice calls. Accordingly, when used in conjunction with a computer terminal, the wireless voice networks were able to transmit or receive data at rates that today are viewed as unacceptably slow.

Along these lines, a mobile station 102 is located within a geographic area served by a Base Transceiver Station (BTS) 104 that is coupled to a Base Station Controller (BSC) 106. More specifically, mobile station 102 can communicate with BTS 104 by way of an IS-95 compliant CDMA wireless communication network link shown generally at 108. Similarly, a mobile terminal 110 that is capable of supporting both voice and data calls communicates with BTS 104 over a wireless communication link shown generally at 112 and establishes either voice calls or data calls under the CDMA2000 1xRTT protocols. In the example herein, mobile terminal 110 is engaged in a voice call, as defined by a service option generated by a mobile terminal during call setup, and thus wireless communication link 112 is transmitting merely voice signals and associated control signaling.

Similarly, a mobile terminal 114 is engaged in a data call according to 1xRTT protocols over a wireless communication link shown generally at 116. Finally, a mobile terminal 118 is engaged in a data call over a wireless communication link, shown generally at 120, according to 1xEVDO protocols in a so called “simple-IP” or “mobile-IP” network, as those terms are understood by one of average skill in the art. In general, simple-IP and mobile-IP networks do not include control-signaling protocols that are as extensive as some existing systems. In particular, simple-IP and mobile-IP networks do not include a “heartbeat” mechanism used to determine that a wireless terminal is present and in an operation mode of operation.

The 1xEVDO network (also known as an “HDR (high data rate) network”) of the described embodiment is a high data rate, high performance and cost effective wireless data packet solution that offers high capacity and is optimized for packet data services. It provides a peak data rate, under current technology, of 2.4 Mbps within one CDMA carrier operating at a bandwidth of 1.2 MHz and supports Internet protocols and further facilitate an “always on” connection so that users are able to rapidly send and receive wireless data. Along these lines, the 1xEVDO network is formed to support connectionless communication links in contrast to traditional connection-oriented networks, such as the PSTN (Public Switched Telephone Network), and transmits Protocol Data Units (PDUs) that comprise data packets layered in a protocol such as the Internet protocol (IP). In general, the 1xEVDO transmits the PDUs in a bursty fashion notwithstanding its underlying CDMA technology. For hybrid mobile terminals capable of supporting both voice and data calls, the 1xEVDO transmits the PDUs for the data on separate 1.25 MHz channels with respect to voice thereby achieving higher system capacity.

1xEVDO network topology is a little different from traditional wireless networks, including 1xRTT data networks. More specifically, while wireless voice networks and 1xRTT data networks all include the use of a BSC and MSC (Mobile Station Controller) for call control and call routing, a 1xEVDO system merely communicates through the radio with an Access Network Controller (“ANC”) that in turn communicates with a packet data serving node which in turn is coupled to a data packet network such as the Internet.

Continuing to examine FIG. 1, BTS 104 is coupled to communicate with ANC/BSC 106. As is understood by one of average skill in the art, Access Network Controllers (ANCs) and Base Station Controllers (BSCs) have similar functionality. Moreover, Packet Control Function Cards can be installed either within a BSC or within an ANC according to whether the Packet Control Function (PCF) is to communicate with a 1xRTT device or a 1xEVDO device, respectively. Additionally, in one embodiment of the invention, one ANC/BSC is formed with 1xRTT and 1xEVDO equipment therewithin to be multi-network capable. Thus, the embodiment of FIG. 1 contemplates such a configuration although it is to be understood that the BSC and ANC elements may readily be separated or formed as stand alone units.

Within ANC/BSC 106, according to one embodiment of the present invention, a plurality of different wireless network cards are included to facilitate communications with mobile stations and mobile terminals of differing protocols and types. For example, in the described embodiment, ANC/BSC 106 includes circuitry to communicate with mobile station 102 over IS-95 CDMA wireless communication network link as shown generally at 108. ANC/BSC 106 further includes a PCF card 122 for communicating with mobile terminals 110 and 114 utilizing 1xRTT protocols in one described embodiment of the invention. As may be seen, PCF 122, which is for communicating with 1xRTT protocol devices, is coupled to an MSC 124. A PCF 126, however, is for communicating with 1xEVDO devices and thus it is coupled directly to a Packet Data Serving Node (PDSN) 128. Thus, mobile terminal 118 that communicates over wireless communication link 120 according to 1xEVDO communication protocols, communicates with BTS 154 and with PCF 126 formed within ANC/BSC 106 according to one embodiment of the present invention. It is understood, of course, that PCF 126 may readily be formed as a distinct device rather than within a rack of ANC/BSC 106. Moreover, PCF 126 may communicate with mobile terminal 118 through distinct radio equipment and, thus, through a BTS other than BTS 154 as shown herein.

MSC 124 further is coupled to a PSTN 130. Accordingly, calls routed through MSC 124 are directed either to other MSCs (not shown herein) or to external networks by way of PSTN 130. The reference to PSTN herein includes SS7 and other similar “intelligent networks”. Thus, a gateway device (not shown herein) coupled to PSTN 130, may be used to access a data packet network, such as the Internet, for any data calls transmitted according to 1xRTT protocols. 1xEVDO calls, which are processed by PCF 126, however, are forwarded through PDSN 128, which, upon authentication by an Authentication, Authorization and Accounting (AAA) server 132, is connected to a data packet network, such as a data packet network 134, which, in this example, comprises the Internet. As may further be seen, data packet network 134 is coupled to a private network 136 by way of a gateway device 138. Private network 136 further is coupled through traditional wire line networks to a user terminal 140 and 142. Moreover, in the described embodiment of the invention, private network 136 includes a wireless LAN formed according to, for example, IEEE Section 802.11(b) protocol standards that facilitates connection to a wireless terminal 144.

Data packet network 134 further is coupled to a plurality of application servers, such as application servers 146 and 148 by way of gateway devices 150 and 152, respectively. Continuing to refer to FIG. 1, ANC/BSC 106 further is coupled to a BTS 154, which is in communication with a mobile terminal 156 by way of a 1xEVDO communication link 158. As may be seen, mobile terminal 156 is served by PCF 126, as is mobile terminal 118, although they are served by different BTSs, namely BTSs 154 and 104, respectively. Additionally, however, a BTS 160 is coupled to a PCF 162 that, in turn, is coupled to communicate with a PDSN 164.

Any one of the mobile terminals 156 or 118 may also communicate through PCF 162 and PDSN 164 whenever they travel through a geographic region that is served by BTS 160. As will be described in greater detail below, one, two or all three of the PCF 122, the PCF 126, the PDSN 128, and the gateway device 138 is/are operable to support header insertion functionality according to the present invention. This will allow for secure identification of the particular user by the application servers 146 and 148. The businesses supporting the application servers 146 and 148 may have business relationships with either the businesses supporting the PCF 122, the PCF 126, the PDSN 128, and/or the gateway device 138 and/or any user who accesses the data packet network 134 by either wireline or wireless means. The application servers 146 and 148 may directly themselves, or indirectly using their gateway devices 150 and 152, employ a private and public key to identify the portal through which the user is accessing the data packet network 134 in order to comply with any predetermined business arrangement they may have together. A variety of embodiments of what may occur during the business relationships between these entities are described below in greater detail.

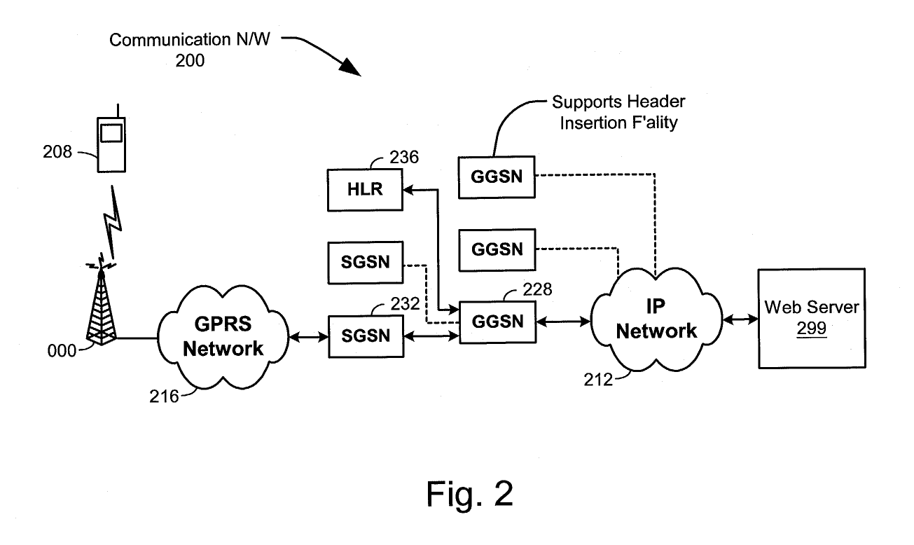

FIG. 2 is a functional block diagram of a communication network formed according to one embodiment of the present invention. More specifically, referring to network 200, a web server 299 is operable to deliver data to a mobile terminal 208 by way of an IP network 212 and a general packet radio service (GPRS) network 216.

IP network 212 also is coupled to a plurality of gateway GPRS gateway support nodes (GGSNs), including GGSN 228. GGSN 228 forms the gateway between IP network 212 and GPRS network 216 that is presently serving mobile terminal 208. Mobile terminal 208 is a GPRS-capable and voice-capable mobile terminal. Continuing to examine FIG. 2, GGSN 228 also is coupled to a serving GPRS support node (SGSN) 232 that is the serving GPRS support node for mobile terminal 208. GGSN 228 also is coupled to a Home Location Register (HLR) 236 that provides, among other things, subscriber verification and authorized feature/service content. In the diagram shown, other SGSNs and GGSNs are shown being coupled to network 200 by way of dashed lines merely to show their presence but that they are not providing any communication support for the present example and, more particularly, for mobile terminal 208. Each of the GGSNs, SGSNs and the HLR 236 are a part of GPRS network 216 but are broken out to illustrate their specific operation according to the present invention.

It is also noted that any one or more of the GGSNs is operable to support header insertion functionality according to the present invention. This way, the user of the mobile terminal 208 may be uniquely identified, either through the actual mobile terminal 208 itself, through the account that the user of the mobile terminal 208 uses to access the GPRS network 216, or some other identification manner. This way, when the user of the mobile terminal 208 interacts with the IP network 212, the user may be uniquely identified either himself/herself or the GPRS network access provider, that enables the user of the mobile terminal 208 to interface with the IP network 212. As will be seen below in other embodiments as well, content providers, that themselves interface with the IP network 212, will be able to identify, in a secure manner, the user or the GPRS network access provider. Any pre-arranged business relationships may then be honored according to the terms and conditions agreed thereon.

The content providers may be viewed as any number of providers whose goods and/or services are accessible via the network. For example, a content provider may be an airline company selling travel related services (such as www.aa.com—the web site of “American Airlines,” for one example); a content provider may be a merchandise company selling a wide variety of goods (such as www.amazon.com—the web site of “Amazon.com,” for yet another example). These two examples are used only as illustration of the wide number of publicly accessible content providers. Those persons having skill in the art will appreciate the wide variety of content providers who may benefit from the present invention in preserving secure identification transfer from users who access their content via network access providers.

The operation of the present invention may also be described as follows within a GPRS system. The GGSN inserts a specific header “ISP ID” which carries the following values: the public key of the ISP and the encoding of IP address of the GGSN, the IP address and/or the MSISDN of the user using the ISP private key. MSISDN stands for Mobile Subscriber Integrated Services Digital Network number in the telephony/communications context. At the content provider, the public key is used to verify against a trusted database of the partner ISP. Then, the content provider decodes a second part (the encrypted/private key) to get more information to verify the user.

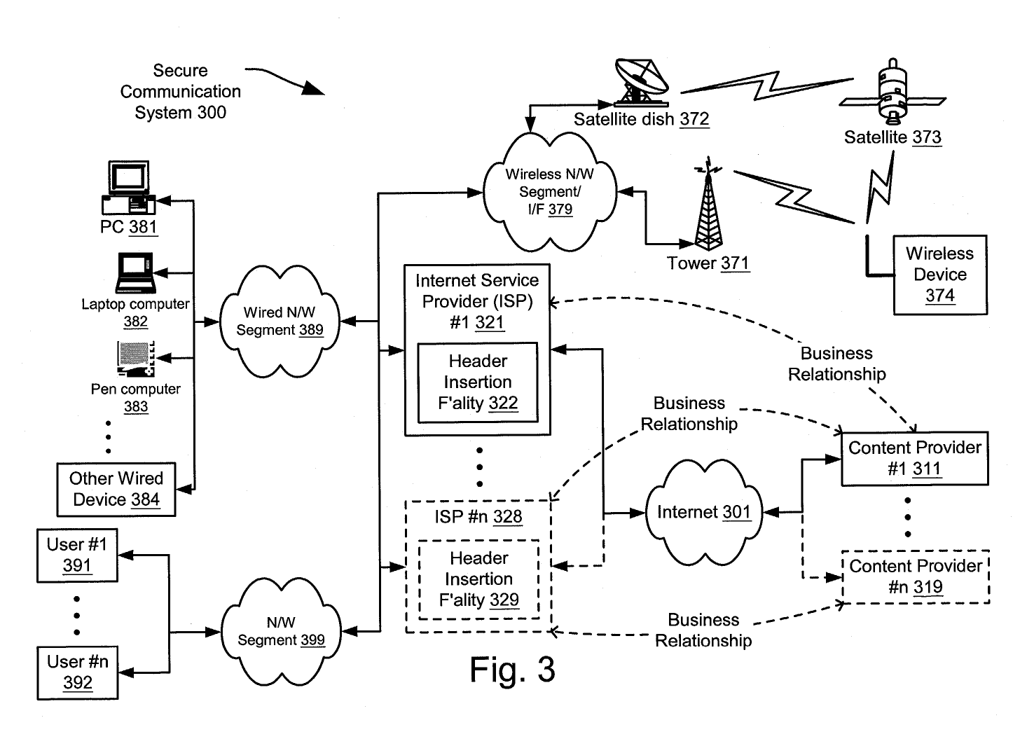

FIG. 3 is a system diagram illustrating an embodiment of a secure communication system 300 that is built according to the present invention. The secure communication system 300 is operable to support a host of various means in which users may interface with the Internet 301. One or more Internet Service Providers (ISPs shown as an ISP #1 321, . . . , and an ISP #n 328) are all operable to service users who desire to access the Internet 301. The interfacing of the users may be via a wired network segment 389, a wireless network segment 379, and/or a generic network segment 399 that may also include proprietary networks, local area networks, wireless LANs, and other network segments.

For example, one or more users (shown as a user #1 391, . . . , and a user #n 392) may interface with one or more of the ISPs 321 . . . 328 to access the Internet 301. Similarly and more specifically, one or more wired devices (such as a personal computer (PC) 381, a laptop computer 382, a pen computer 383, . . . , and/or any other wired device 384) may interface with the wired network segment 389 to communicatively couple to the one or more of the ISPs 321 . . . 328 to access the Internet 301.

In the wireless context, one or more wireless devices (such as a wireless device 374) may interface with the wireless network segment/interface 379 to communicatively couple to the one or more of the ISPs 321 . . . 328 to access the Internet 301. A user of the wireless devise 374 may interface with the wireless network segment/interface 379 directly, through a wireless communications BTS tower 371, or indirectly through a satellite 373 and a satellite dish 372 that are communicatively coupled to the wireless network segment/interface 379. Satellite capable wireless devices are therefore also included within the scope and spirit of the invention. The ISPs 321 . . . 328 may themselves include functionality to support interfacing with both wireline and wireless network segments. Alternatively, some of the ISPs 321 . . . 328 may support wireless interfacing functionality, and other of the ISPs 321 . . . 328 may support wireline-interfacing functionality.

A user of any Internet accessible device is then operable to access one or more content providers (shown as a content provider #1 311, . . . , and a content provider #n 319). These content providers 311 . . . 319 may have business relationships with one or more of the ISPs 321 . . . 328. Alternatively, the content providers 311 . . . 319 may have business relationships with the users of the Internet accessible devices themselves. Each of the ISPs 321 . . . 328 is operable to support header insertion functionality, and each of the content providers 311 . . . 319 are operable to extract the inserted header and securely identify the ISP through which the user access the content provider and, in some cases, to securely identify the actually user himself/herself according to the present invention. For example, the ISP #1 321 is operable to support header insertion functionality 322, and the ISP #n 328 is operable to support header insertion functionality 329.

It is therefore noted that the ISPs 321 . . . 328 and the content providers 311 . . . 319 are operable, cooperatively to perform secure identification of users who access the Internet 301. This way, any user who interfaces with the Internet 301 will be able to be uniquely identified (either as the user himself/herself, through the ISP account of the user, and/or by the ISP itself). Those persons having skill in the art will appreciate the extendibility and applicability of the secure identification of these entities by a content provider/partner that provides content to the Internet 301. This way, when the user interacts with the Internet 301, the user may be uniquely identified either himself/herself or through his/her ISP, that enables the user to interface with the Internet 301. Any pre-arranged business relationships (between ISPs 321 . . . 328 and the content providers 311 . . . 319, between the users and the ISPs 321 . . . 328 and/or the content providers 311 . . . 319) may then be honored according to the terms and conditions agreed thereon.

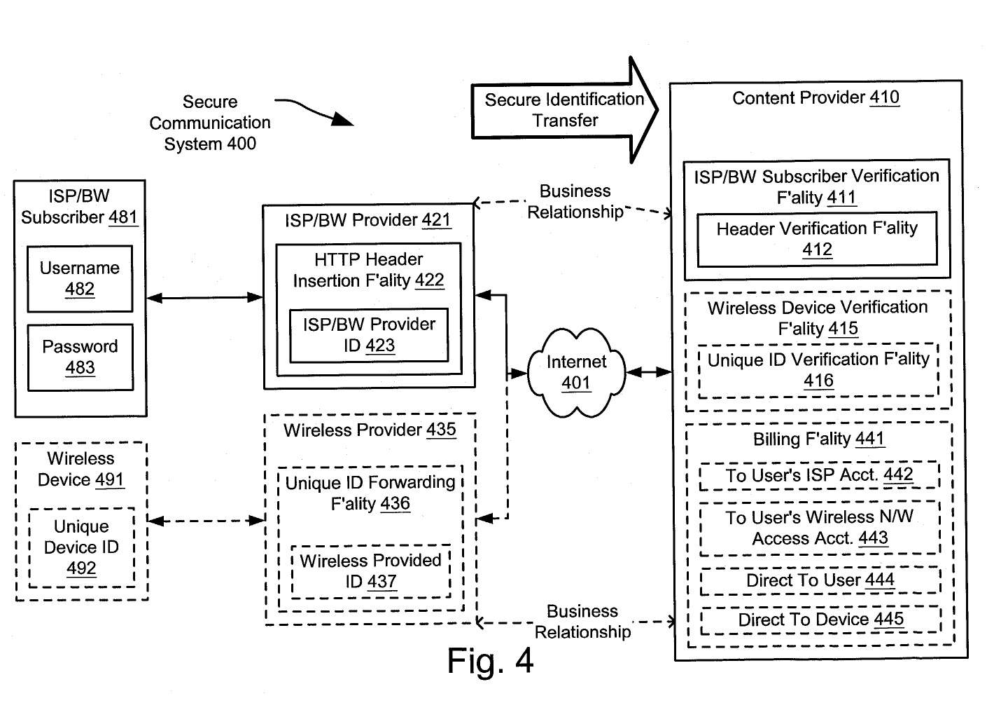

FIG. 4 is a system diagram illustrating another embodiment of a secure communication system 400 that is built according to the present invention. An ISP/bandwidth (BW) subscriber 481 is able to access an ISP/BW provider 421 by providing a username 482 and a password 483. The ISP/BW provider 421 is operable to perform Hyper Text Transfer Protocol (HTTP) header insertion functionality 422 in which the ISP/BW provider 421 is able to include an ISP/bandwidth provider id 423 therein. The ISP/BW provider 421 then enables the ISP/bandwidth subscriber 481 to interface and communicate with the Internet 401. One or more content providers are accessible via the Internet 401, one shown specifically as a content provider 410.

Analogously, wireless device 491 (uses by a wireless user) is able to access a wireless provider 435 by providing a unique device identification 492 of the user's wireless device 491. The wireless provider 435 is operable to support unique identification forwarding functionality 436 that includes providing a wireless provided identification 437 when performing the interfacing of the wireless network segment with the Internet 401. Then, the wireless provider 435 then enables the user of the wireless device 491 to interface and communicate with the Internet 401.

The content provider 410 may have a business relationship/partnership with the ISP/BW provider 421 and/or the wireless provider 435. It is therefore noted that the content provider 410 and the ISP/BW provider 421 and/or the wireless provider 435 is/are operable, cooperatively to perform secure identification of users who access their content via the Internet 401. This way, any user who interfaces with the Internet 401 will be able to be uniquely identified (either as the user himself/herself, through the ISP/BW provider account of the user, by the wireless provider account of the user, and/or through the ISP/BW provider or the wireless provider itself). Those persons having skill in the art will appreciate the extendibility and applicability of the secure identification of these entities by a content provider/partner that provides content to the Internet 401. This way, when the user interacts with the Internet 401, the user may be uniquely identified either himself/herself or by his/her Internet access provider (be it wireline or wireless), that enables the user to interface with the Internet 401. Any prearranged business relationships (the content provider 410 and the ISP/BW provider 421 and/or the wireless provider 435) may then be honored according to the terms and conditions agreed thereon.

The content provider 410 is operable to support a variety of functionalities. For example, the content provider 410 is operable to support ISP/BW subscriber verification functionality 411 in which the content provider 410 supports header verification functionality 412. Secure identification transfer may be made of the users that access the content provider 410. Similarly, the content provider 410 is operable to support wireless device verification functionality 415 in which the content provider 410 supports unique identification verification functionality 416 of the wireless device 491; the identification of the wireless device 491 may then be attributed back to the wireless subscriber (wireless user) of the wireless device 491 if desired.

The content provider 410 is also operable to support billing functionality 441 as well. The billing functionality 441 will support billing of access to the content of the content provider 410 (as well as purchases of goods and services provided through the content provider 410) to the user's ISP account, as shown in a functional block 442. Alternatively, the billing functionality 441 will support billing to a user's wireless network access account, as shown in a functional block 443. If desired, the billing functionality 441 will support billing directly to the user 444 (or to his/her ISP account) or directly to the device 445 (or to the account of the user who uses the device 445—such as to the wireless device 491). In addition, the billing functionality 441 may also support predetermined discounts for the users (be they wireline or wireless) based on their Internet access provider (be it the ISP/bandwidth provider 421 or the wireless provider 435). In addition, the billing functionality 441 may support functionality that allows costs/revenue sharing with the partner with whom they have the business relationship according to the terms agreed thereupon by access and/or purchases made by the users to the site of the content provider 410.

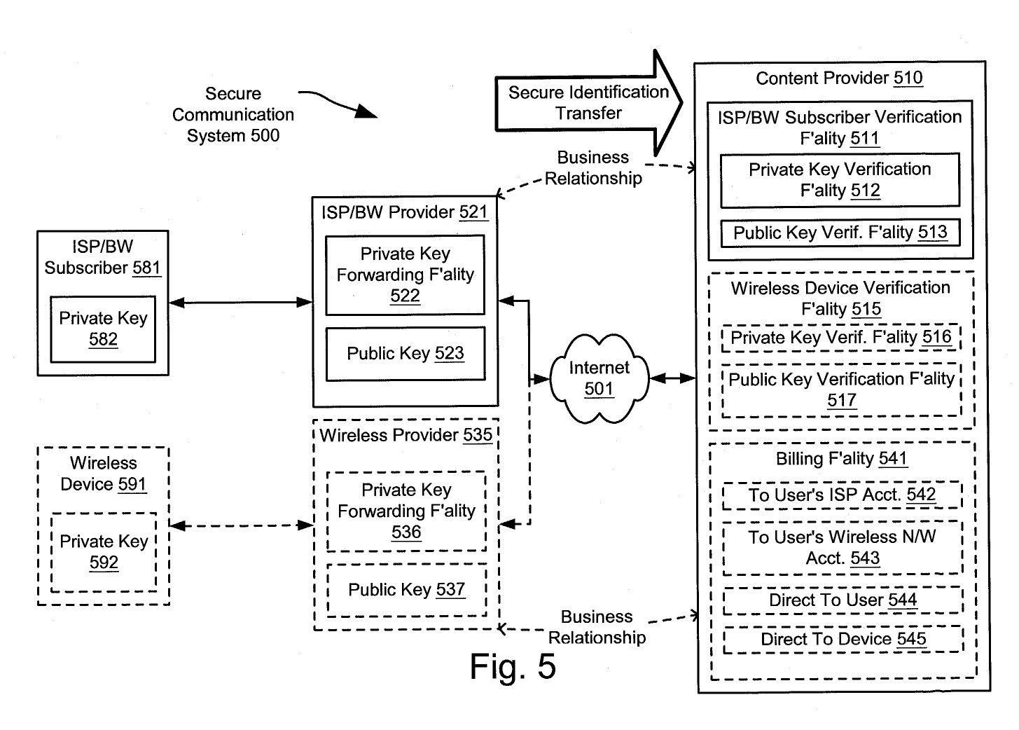

FIG. 5 is a system diagram illustrating another embodiment of a secure communication system 500 that is built according to the present invention. An ISP/bandwidth (BW) subscriber 581 is able to access an ISP/BW provider 521 and in doing so by providing a private key that is encrypted so as not to be accessible via transport to the ISP/BW provider 521 and the Internet 501. The ISP/BW provider 521 is operable to support private key forwarding 522 of the private key associated with the ISP/BW subscriber 581. In addition, the ISP/BW provider 521 is operable to provide a public key 523 that will allow a content provider 510 to identify the ISP/BW provider 521 for all of its associated subscribers. The ISP/BW provider 521 then enables the ISP/bandwidth subscriber 581 to interface and communicate with the Internet 501. One or more content providers are accessible via the Internet 501, one shown specifically as the content provider 510.

Analogously, wireless device 591 (uses by a wireless user) is able to access a wireless provider 535 by providing a private key 592 associated with the wireless device 591. The wireless provider 535 is operable to support private key forwarding functionality 536. In addition, the wireless provider 535 is operable to provide a public key 537 that will allow a content provider 510 to identify the wireless provider 535 for all of its associated wireless subscribers when performing the interfacing of the wireless network segment with the Internet 501. Then, the wireless provider 535 then enables the user of the wireless device 591 to interface and communicate with the Internet 501.

The content provider 510 may have a business relationship/partnership with the ISP/BW provider 521 and/or the wireless provider 535. It is therefore noted that the content provider 510 and the ISP/BW provider 521 and/or the wireless provider 535 is/are operable, cooperatively to perform secure identification of users who access their content via the Internet 501. This way, any user who interfaces with the Internet 501 will be able to be uniquely identified (either as the user himself/herself, through the ISP/BW provider account of the user, by the wireless provider account of the user, and/or by the ISP/BW provider or the wireless provider itself). Those persons having skill in the art will appreciate the extendibility and applicability of the secure identification of these entities by a content provider/partner that provides content to the Internet 501. This way, when the user interacts with the Internet 501, the user may be uniquely identified either himself/herself or through his/her Internet access provider (be it wireline or wireless), that enables the user to interface with the Internet 501. Any pre-arranged business relationships (the content provider 510 and the ISP/BW provider 521 and/or the wireless provider 535) may then be honored according to the terms and conditions agreed thereon.

The content provider 510 is operable to support a variety of functionalities. For example, the content provider 510 is operable to support ISP/BW subscriber verification functionality 511 in which the content provider 510 supports both public key verification functionality 513 to identify ISP/bandwidth provider 521 and private key verification functionality 513 to identify the actual user himself/herself and/or the device that the user employs to access the Internet 501 and the content of the content provider 510. Secure identification transfer may be made of the users that access the content provider 510 in the wireline manner.

Similarly, the content provider 510 is operable to support wireless device verification functionality 515 in which the content provider 510 supports both public key verification functionality 517 to identify the wireless provider 535 and private key verification functionality 513 to identify the actual user himself/herself and/or the device that the user employs to access the Internet 501 and the content of the content provider 510. Secure identification transfer may then also be made of the users that access the content provider 510 in the wireless manner.

The content provider 510 is also operable to support billing functionality 541 as well. The billing functionality 541 will support billing of access to the content of the content provider 510 (as well as purchases of goods and services provided through the content provider 510) to the user's ISP account, as shown in a functional block 542. Alternatively, the billing functionality 541 will support billing to a user's wireless network access account, as shown in a functional block 543. If desired, the billing functionality 541 will support billing directly to the user 544 or directly to the device 545. In addition, the billing functionality 541 may also support predetermined discounts for the users (be they wireline or wireless) based on their Internet access provider (be it the ISP/bandwidth provider 521 or the wireless provider 535). In addition, the billing functionality 541 may support functionality that allows costs/revenue sharing with the partner with whom they have the business relationship according to the terms agreed thereupon by access and/or purchases made by the users to the site of the content provider 510.

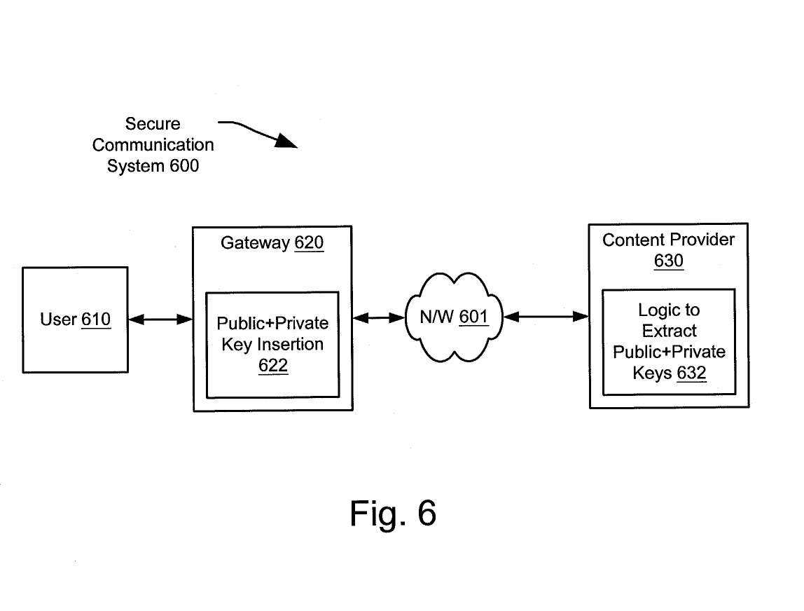

FIG. 6 is a system diagram illustrating another embodiment of a secure communication system 600 that is built according to the present invention. The secure communication system 600 of the FIG. 6 shows a very generic embodiment that still captures the scope and spirit of the invention. A user 610 employs a gateway 620 to access a network 601. A content provider 630 is communicatively coupled to the network 601, and the user 610 may access the content supported by the content provider 630.

The gateway 620 is operable to perform public+private key insertion to data that are transferred to the network 601 from the user 610 when the user 610 seeks to access the content provider 630. Then, the content provider employs logic, as shown in a functional block 632, to extract the public+private keys to perform secure identification of the gateway 620 and/or the user 610.

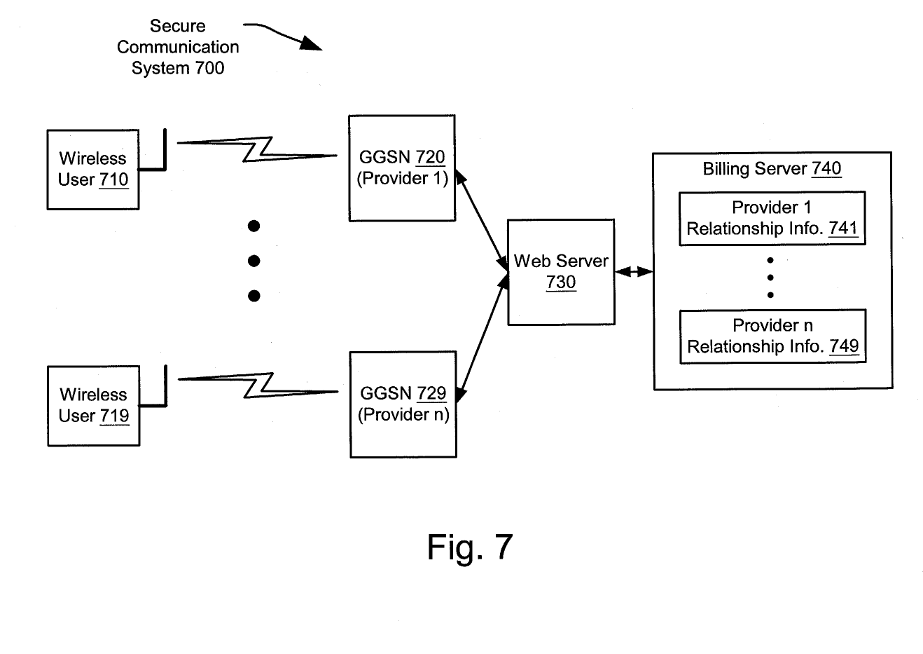

FIG. 7 is a system diagram illustrating another embodiment of a secure communication system 700 that is built according to the present invention. One or more wireless users (shown as wireless user 710, . . . , and wireless user 719) interact with one or more GGSNs (shown as GGSN 720 as a provider 1, . . . , and GGSN 729 as a provider n) to interface with a web server 730. Clearly, the Internet and/or one or more network segments may be in the interim between the GGSNs 720 . . . 729 and the web server. In some embodiment, the web server 730 is operable to interface directly with the GGSNs. A billing server communicatively couples to the web server 730. The billing server 740 includes information for the business relationships between the providers 1 . . . n, as shown in blocks 741, . . . , and 749.

For example, the billing server 740 may provide one discount to the wireless user 710 who access the web server 730 via the GGSN 720 (provider 1) and another discount to the wireless user 719 who access the web server 730 via the GGSN 729 (provider n). The billing server 740 is then operable to enable costs/revenue sharing with the GGSN/partner with whom they have the business relationship according to the terms agreed thereupon by access and/or purchases made by the wireless users 710 . . . 719 to the web server 730. There are an innumerable number of types of business arrangements that may be included within the business relationships between the web server and the providers of the GGSNs.

The FIG. 7 shows an embodiment where in a GPRS wireless system, the GGSN can insert a header that looks like the following: Aggregate-Provider: Private-Key (Provider name, GGSN IP address/name, MSISDN)+Public Key. The content provider can use the public key to validate against its database and provide any appropriate discount rate for transaction items. In an HTTP/WAP client request, the border box (such as the GGSN in a GPRS system) of a ISP/BW provider may insert a specific header carried digital signature of the ISP/BW provider. The content provider then logs the client request along with the header that may then be used to identify which ISP/BW provider the transaction has originated.

It is also noted that certain systems, according to the present invention, can employ techniques to prevent copy of the header that includes the public key and the private key (encrypted portion). These approaches may involve any number of means to ensure and verify that the request is actually coming from the partner network access provider (be it an ISP or a wireless network provider), including employing time stamps, employ random number sequences, and other means.

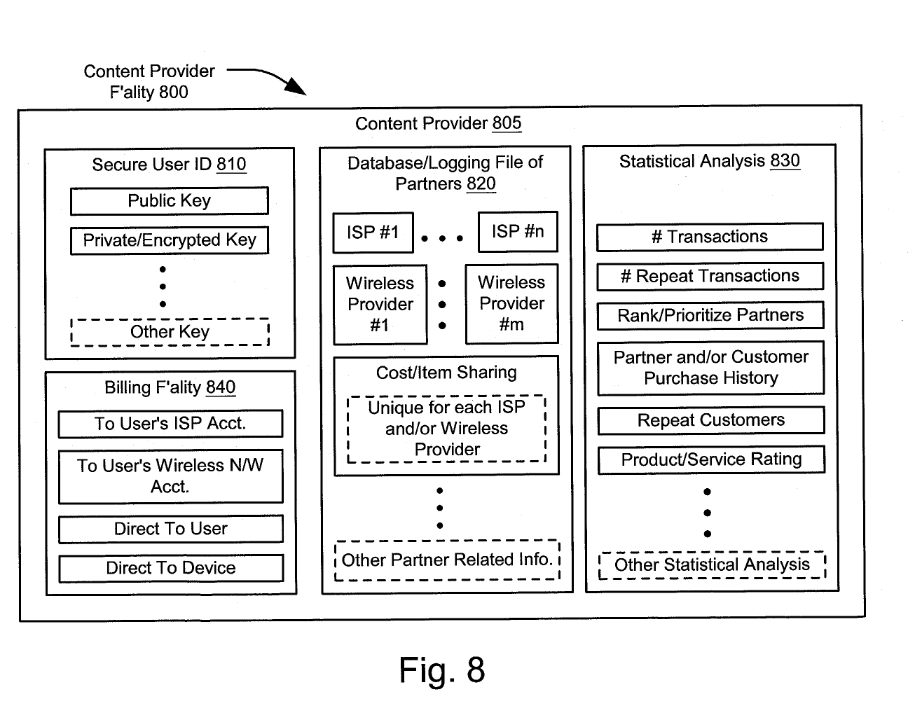

FIG. 8 is a diagram illustrating an embodiment of content provider functionality 800 that is supported according to the present invention. The content provider functionality 800 includes functionality arranged within a content provider 805. The content provider 805 is operable to perform secure user identification 810 using a public key, a private key, . . . , and/or any other key according to the present invention.

The content provider 805 is also operable to support billing functionality 840. The billing functionality 840 will support billing of access to the content of the content provider 805 (as well as purchases of goods and services provided through the content provider 805) to the user's ISP account, to a user's wireless network access account. If desired, the billing functionality 840 will support billing directly to the user or directly to the device. In addition, the billing functionality may also support predetermined discounts for the users (be they wireline or wireless) based on their Internet access provider (be it an ISP/bandwidth provider or a wireless provider). In addition, the billing functionality 840 may support functionality that allows costs/revenue sharing with the partner with whom they have the business relationship according to the terms agreed thereupon by access and/or purchases made by the users to the site of the content provider 805.

The content provider 805 is operable to support a database/logging file of partners 820 with whom the content provider 805 has business relationships. This includes a listing of the ISPs themselves (ISP #1 . . . ISP #n), a listing of wireless providers (wireless provider #1 . . . wireless provider #n). In addition, the database/logging file of partners 820 includes cost/item sharing between the content provider 820 and the network access providers. This may include unique cost/item sharing for each of the ISPs and/or wireless providers. Moreover, any other partner related information may be included within this database/logging file of partners 820.

The content provider 805 is also operable to support statistical analysis 830 of interactions/transactions by users who interact with the content provider 805. The statistical analysis 830 may involve tracking the number of transactions, the number of repeat transactions, a ranking/prioritization of network access provider partners. The statistical analysis 830 may also involve keeping track of partner and/or customer purchase histories, logging repeat customers, and rating the products/services provided by the content provider. In addition, any other statistical analysis may be supported within the statistical analysis 830 supported by the content provider 805.

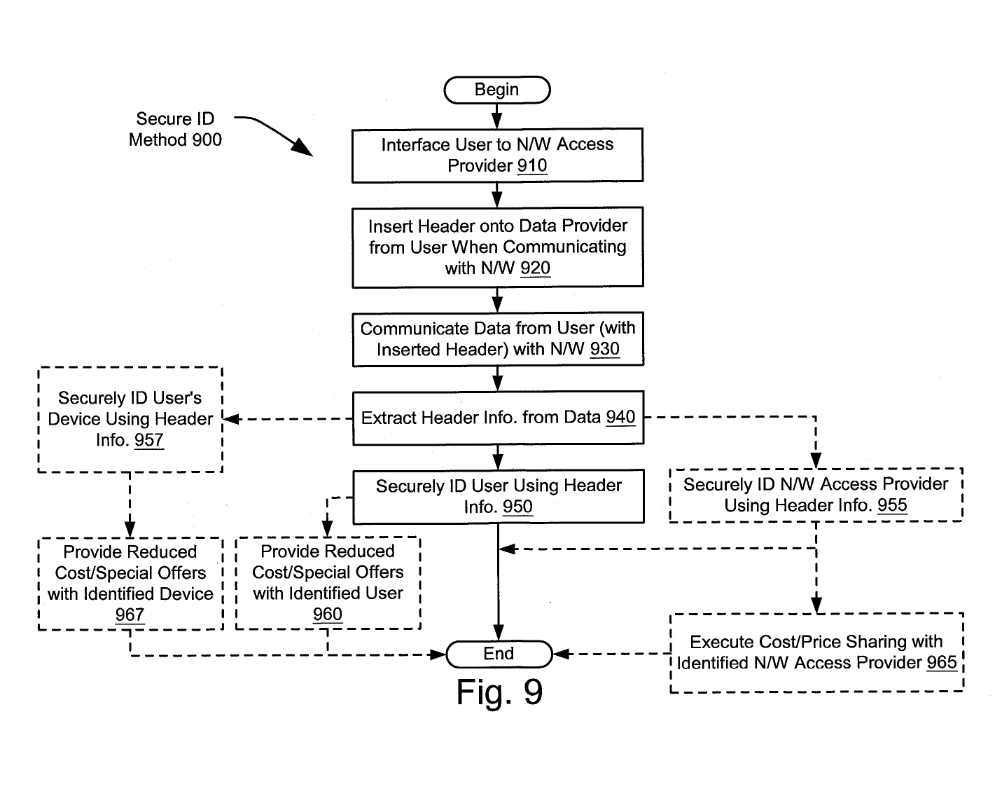

FIG. 9 is an operational flow diagram illustrating an embodiment of a secure identification method 900 that is performed according to the present invention. In a block 910, a user interfaces to a network access provider. Then, a header is inserted onto data from the user when the user uses the network access provider to communicate with a network as shown in a block 920. In a block 930, data is actually communicated from the user to the network; this communicated data includes the inserted header.

After the data is received after having traversed across the network, the header information is extracted from the data as shown in a block 940. Then, in a block 950, this header information is used to perform secure identification of the user that interfaces to the network access provider and thereafter to the network.

In alternative embodiments, the secure identification method 900 continues from the block 940 to perform secure identification the network access provider that the user employs to access the network as shown in a block 955. The secure identification method 900 may then terminate after performing the function of the block 955; alternatively, the secure identification method 900 may continue on to perform execution of cost/price sharing with the identified network access provider as shown in a block 965 before ending.

In yet another embodiment, after performing the operation in the block 940, the secure identification method 900 will securely identify a user's device using the4 header information as shown in a block 957. Afterwards, the secure identification method 900 will provide reduced cost/special offers with the identified device as shown in a block 967. In even other embodiments, after performing the operation in the block 950, the secure identification method 900 will provide reduced cost/special offers with the identified user as shown in a block 960.

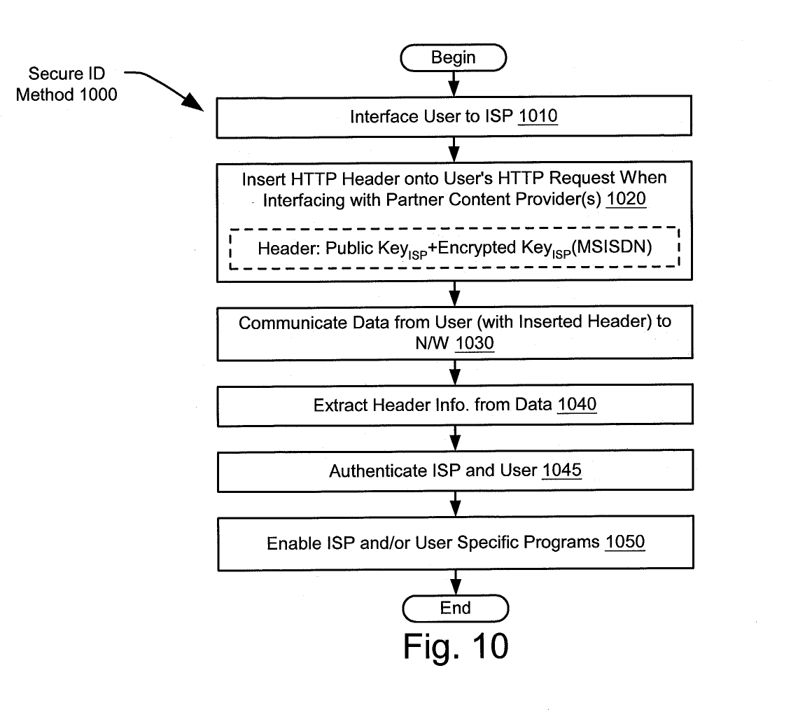

FIG. 10 is an operational flow diagram illustrating another embodiment of a secure identification method 1000 that is performed according to the present invention. As shown in a block 1010, a user interfaces with an ISP. Then, an HTTP header is inserted into the user's HTTP request when interfacing with one or more partner content provider(s) who have business relationships with the ISP as shown in a block 1020. This may include inserting a header that includes a public key and a private key provided from the ISP. The public key may be used generically to identify the ISP, and the private key may be used to identify specifically the user (or the user's account with the ISP). A form of the HTTP header may look like: Public Key_{ISP}+Encrypted Key_{ISP}(MSISDN).

In a block 1030, data (with the inserted header) is communicated from the user to the network. In a block 1040, the header information is extracted from the data. In a block 1045, the ISP and user are authenticated based on the decoding of the public and private key. Then, using this authenticated information, any ISP and/or user specific programs that are supported by a content provider may be proffered as shown in a block 1050.

By providing a very secure and effective way to identify the ISP/BW provider in the content provider context, the present invention opens a whole new level of service for ISP/BW providers to provide advanced services and to form partnerships with various content providers. This will help generate, among other things, a new way to generate more revenue for ISP/BW providers than simply the pure selling of bandwidth only. Moreover, the present invention provides a very elegant solution to a long existing problem that is also very easily detectable within copycat systems.

In view of the above detailed description of the invention and associated drawings, other modifications and variations will now become apparent to those skilled in the art. It should also be apparent that such other modifications and variations may be effected without departing from the spirit and scope of the invention.

What is claimed is:

1. A secure communication network, comprising:
an Internet service provider, comprising header insertion functionality, that receives a user's request, the header insertion functionality being operable to insert a digital signature header of the Internet service provider in the user's request; and
a content provider that receives the user's request and extracts the digital signature header there from to identify the Internet service provider; and
wherein the digital signature header comprises a public key corresponding to the Internet service provider and encryption of at least one of an Internet protocol address and a mobile subscriber integrated services digital network number of the user using the Internet service provider; and
the encryption being supported using a private key associated with the public key.

2. The secure communication network of claim 1, wherein the content provider uses the public key to decode the encryption of at least one of the Internet protocol address and the mobile subscriber integrated services digital network number of the user using the Internet service provider.

3. The secure communication network of claim 1, further comprising a wireline network segment that communicatively couples to the Internet service provider;
the user communicatively couples to the wireline network segment; and
the content provider uses the public key to decode the encryption of at least one of the Internet protocol address and the mobile subscriber integrated services digital network number of the user using the Internet service provider thereby identifying an Internet service provider of the user.

4. The secure communication network of claim 1, further comprising a wireless network segment interface that communicatively couples to the Internet service provider;
the user employs a wireless device to communicatively couple to the wireline network segment; and
the content provider uses the public key to decode the encryption of at least one of the Internet protocol address and the mobile subscriber integrated services digital network number of the user using the Internet service provider thereby identifying the wireless device.

5. The secure communication network of claim 1, wherein the content provider and the Internet service provider having a predetermined business relationship; and
the content provider offers a discount from at least one of a good and a service offered to the user at the content provider according to the predetermined business relationship.

6. The secure communication network of claim 1, wherein the user's request comprises a hyper text transfer protocol request.

7. The secure communication network of claim 1, wherein the content provider supports statistical analysis of a transaction performed by the user and at least one additional transaction performed by at least one additional user.

8. A secure communication network, comprising:
an Internet service provider, comprising header insertion functionality, that receives a user's hyper text transfer protocol request, the header insertion functionality being operable to insert a digital signature header of the Internet service provider in the user's hyper text transfer protocol request; and
a content provider that receives the user's hyper text transfer protocol request and extracts the digital signature header there from to identify the Internet service provider; and
wherein the digital signature header comprises a public key corresponding to the Internet service provider and encryption of at least one of an Internet protocol address and a mobile subscriber integrated services digital network number of the user using the Internet service provider;
the content provider uses the public key to decode the encryption of at least one of the Internet protocol address and the mobile subscriber integrated services digital network number of the user using the Internet service provider;
the content provider supports statistical analysis of a transaction performed by the user and at least one additional transaction performed by at least one additional user; and
the content provider and the Internet service provider having a predetermined business relationship.

9. The secure communication network of claim 8, wherein the statistical analysis comprising at least one of tracking a number of user transactions and tracking a number of repeat transactions.

10. The secure communication network of claim 8, further comprising a wireline network segment that communicatively couples to the Internet service provider;
the user communicatively couples to the wireline network segment; and
the content provider uses the public key to decode the encryption of at least one of the Internet protocol address and the mobile subscriber integrated services digital network number of the user using the Internet service provider thereby identifying an Internet service provider of the user.

11. The secure communication network of claim 8, further comprising a wireless network segment interface that communicatively couples to the Internet service provider;
the user employs a wireless device to communicatively couple to the wireline network segment; and
the content provider uses the public key to decode the encryption of at least one of the Internet protocol address and the mobile subscriber integrated services digital network number of the user using the Internet service provider thereby identifying the wireless device.

12. The secure communication network of claim 11, wherein the wireless network segment interface comprises a gateway general packet radio service support node.

13. The secure communication network of claim 8, wherein the content provider supports billing functionality that is operable to perform billing a user purchase to a user Internet service provider account.

14. A secure identification method, comprising:
providing a user's data packet to an Internet service provider;
inserting a header within the user's data packet, the header comprising a digital signature header that comprises a public key corresponding to the Internet service provider and encryption of at least one of an Internet protocol address and a mobile subscriber integrated services digital network number of the user using the Internet service provider;
authenticating the public key of the Internet service provider against a plurality of stored Internet service provider public keys; and
using the public key to decode the encryption of at least one of the Internet protocol address and the mobile subscriber integrated services digital network number of the user using the Internet service provider.

15. The method of claim 14, wherein the header is inserted within the user's data packet within the Internet service provider; and
the user's data packet comprises a hyper text transfer protocol request.

16. The method of claim 14, wherein the user's data packet is provided from a gateway general packet radio service support node; and
wherein the header is inserted within the user's data packet within the gateway general packet radio service support node.

17. The method of claim 14, wherein the user employs at least one of a wireline Internet device and a wireless device;
the wireline Internet device being operable to interface with the Internet service provider;
the wireless device being operable to with a wireless provider; and
each of the Internet service provider and the wireless provider being operable to interface with the Internet.

18. The method of claim 14, wherein:
the authenticating of the public key of the Internet service provider against a plurality of stored Internet service provider public keys being performed within a content provider; and
the using of the public key to decode the encryption of at least one of the Internet protocol address and the mobile subscriber integrated services digital network number of the user using the Internet service provider being performed within the content provider.

19. The method of claim 18, wherein the content provider and the Internet service provider having a predetermined business relationship that comprises offering a discount from at least one of a good and a service offered to the user at the content provider.

20. The method of claim 14, further comprising performing statistical analysis of a transaction performed by the user and at least one additional transaction performed by at least one additional user.
